(19) United States
(12) Patent Application Publication
(10) Pub. No.: US 2013/0089307 A1
(43) Pub. Date: Apr. 11, 2013

(54) BROADCAST RECEIVING AND RECORDING APPARATUS, BROADCAST RECEIVING AND RECORDING METHOD, AND BROADCAST RECEIVING AND RECORDING PROGRAM

(71) Applicant: JVC Kenwood Corporation, Yokohama-Shi (JP)

(72) Inventor: Yoshihito KINOSHITA, Sagamihara-Shi (JP)

(73) Assignee: JVC KENWOOD CORPORATION, Yokohama-Shi (JP)

(21) Appl. No.: 13/688,416

(22) Filed: Nov. 29, 2012

Related U.S. Application Data
(63) Continuation of application No. PCT/JP2011/062284, filed on May 27, 2011.

(30) Foreign Application Priority Data
Jun. 1, 2010 (JP) 2010-126337

(51) Int. Cl. H04N 9/79

(52) U.S. Cl. CPC H04N 9/79
USPC 386/297

(57) ABSTRACT

Preset information that is preset for preset-recording that is an automatic recording mode for recording a broadcast program in accordance with the preset information is stored in a storage unit. Preset-recording identification information that identifies the preset information is also stored in the storage unit. A broadcast receiving unit receives a broadcast program in accordance with preset information that has been preset for preset-recording of the received broadcast program. Identification information is added to data of the received broadcast program and the data with the identification information is stored in a storage unit. When the identification information added to the stored data of the received broadcast is edited, preset-recording that has been set for the stored data of the received broadcast program is identified and preset-recording identification information that corresponds to the preset-recording is modified based on the edited identification information.

### CROSS-REFERENCE TO RELATED APPLICATIONS

This application is a continuation of International Application No. PCT/JP2011/062284 filed on May 27, 2011, based on and claims the benefit of priority from the prior Japanese Patent Application No. 2010-126337 filed on Jun. 1, 2010, the entire content of which is incorporated herein by reference.

### BACKGROUND OF THE INVENTION

The present invention relates to a broadcast receiving and recording apparatus, a broadcast receiving and recording method, and a broadcast receiving and recording program.

There is a recorder that has a function of preset-recording that is an automatic recording mode in which a user presets several pieces of information such as a broadcast program name to be recorded, a day and time at which a broadcast program is recorded, a TV channel or a frequency at which a broadcast program is received and recorded, etc.

Moreover, there is a recorder for recording a TV (television) broadcast program by preset-recording using an EPG (Electronic Program Guide). Such type of recorder uses a TV program name acquired from the EPG as preset-recording ID (identification) information that identifies a TV broadcast program preset by a user for preset-recording. A TV program name acquired from the EPG is also used as a file name for broadcast data that is image and/or audio data of a TV broadcast program recorded by preset-recording. It is therefore easy to identify the information preset for preset-recording and the contents of recorded broadcast data by referring to a file name.

Different from TV broadcast preset-recording, radio broadcast preset-recording cannot use the EPG, hence requires presetting of a modulation mode, (amplitude modulation, frequency modulation, etc.), a frequency, a date, a time range, etc. Preset-recording ID information is usually a combination of these factors. It is therefore not easy to identify the information preset for preset-recording by referring to preset-recording ID information in radio broadcast preset-recording. Identification of the contents of a data file recorded by preset-recording is also difficult because the data file is given a name similar to the preset-recording ID information in radio broadcast preset-recording.

Moreover, in the case of radio broadcast preset-recording, if a user wants to modify file names to easily identifiable names such as broadcast program names, it is required to specify each file, and change and modify it. In addition, preset-recording ID information cannot be changed or modified by changing a file name of a recorded file only. Therefore, if a user also wants to modify preset-recording ID information to an easily identifiable one, it is required to change or modify preset-recording ID information, in addition to a file name.

As discussed above, known recorders for radio broadcast preset-recording have a problem in that it is difficult to identify the information preset for preset-recording and the contents of recorded broadcast data. Another problem for known recorders for radio broadcast preset-recording lies in difficulty in modification of preset-recording ID information and recorded file name.

Similar problems lie in preset-recording of any broadcast such as online broadcast, wireless broadcast, etc., with no broadcast information such as an EPG, in addition to radio broadcast reception and recording.

### SUMMARY OF THE INVENTION

A purpose of the present invention is to provide a broadcast receiving and recording apparatus, a broadcast receiving and recording method, and a broadcast receiving and recording program with a specific function by which a user can easily identify the information preset for preset-recording and the contents of recorded broadcast program data.

The present invention provides a broadcast receiving and recording apparatus comprising: a first storage unit configured to store preset information that is preset for preset-recording that is an automatic recording mode for recording a broadcast program in accordance with the preset information and store preset-recording identification information that identifies the preset information so that the preset information and the preset-recording identification information correspond to each other; a broadcast receiving unit configured to receive a broadcast program in accordance preset information that has been preset for preset-recording of the received broadcast program; a second storage unit configured to store data of the received broadcast program; a received-data recording unit configured to add storage identification information, that identifies the data of the received broadcast program in accordance with preset information that has been preset and stored in the first storage unit for preset-recording of the received broadcast program, to the data of the received broadcast program and to record the data of the received broadcast program added with the storage identification information in the second storage unit so that the data of the received broadcast program added with the storage identification information corresponds to the preset-recording identification information that identifies the preset information that has been preset for preset-recording of the received broadcast program; an editor unit configured to edit the storage identification information added to the data of the received broadcast program and stored in the second storage unit; and a modifier unit configured, when the storage identification information added to the data of the received broadcast program and stored in the second storage unit is edited, to modify the preset-recording identification information stored in the first storage unit and corresponding to the storage identification information added to the data of the received broadcast program and stored in the second storage unit, based on the edited storage identification information.

Moreover, the present invention provides a broadcast receiving and recording method comprising the steps of: storing preset information that is preset for preset-recording that is an automatic recording mode for recording a broadcast program in accordance with the preset information and storing preset-recording identification information that identifies the preset information; receiving a broadcast program in accordance with preset information that has been preset for preset-recording of the received broadcast program; adding identification information to data of the received broadcast program and storing the data with the identification information; and when the identification information added to the stored data of the received broadcast is edited, identifying preset-recording that has been set for the stored data of the received broadcast program and modifying preset-recording identification information that corresponds to the preset-recording based on the edited identification information.

Furthermore, the present invention provides a non-transitory computer readable storage medium storing a computer program running on a computer to achieve function of a broadcast receiving and recording apparatus, the program comprising: a program code of storing preset information that is preset for preset-recording that is an automatic recording mode for recording a broadcast program in accordance with the preset information and storing preset-recording identification information that identifies the preset information so that the preset information and the preset-recording identification information correspond to each other; a program code of receiving a broadcast program in accordance preset information that has been preset for preset-recording of the broadcast program; a program code of storing data of a broadcast program received in accordance with the preset information, added with storage identification information that identifies the data of the received broadcast program and includes preset-recording identification information corresponding to the data of the received broadcast program; a program code of editing the storage identification information added to the stored data; and a program code of, when the preset-recording identification information included in the storage identification information is edited, modifying the stored preset-recording identification information to the contents of the edited preset-recording identification information.

Still furthermore, the present invention provides a computer program running on a computer to achieve function of a broadcast receiving and recording apparatus, the program comprising: a program code of storing preset information that is preset for preset-recording that is an automatic recording mode for recording a broadcast program in accordance with the preset information and storing preset-recording identification information that identifies the preset information so that the preset information and the preset-recording identification information correspond to each other; a program code of receiving a broadcast program in accordance preset information that has been preset for preset-recording of the broadcast program; a program code of storing data of a broadcast program received in accordance with the preset information, added with storage identification information that identifies the data of the received broadcast program and includes preset-recording identification information corresponding to the data of the received broadcast program; a program code of editing the storage identification information added to the stored data; and a program code of, when the preset-recording identification information included in the storage identification information is edited, modifying the stored preset-recording identification information to the contents of the edited preset-recording identification information.

### BRIEF DESCRIPTION OF DRAWINGS

FIG. 1 is a block diagram schematically showing the configuration of a broadcast receiving and recording apparatus according to a first embodiment of the present invention;

FIG. 2 is a view showing an exemplary structure a preset-information database;

FIG. 3 is a flowchart explaining a recording preset process performed by the broadcast receiving and recording apparatus according to the first embodiment of the present invention;

FIG. 4 is a view showing an example of an information preset window;

FIG. 5 is a flowchart explaining a recording start process performed by the broadcast receiving and recording apparatus according to the first embodiment of the present invention;

FIG. 6 is a flowchart explaining a recording end process performed by the broadcast receiving and recording apparatus according to the first embodiment of the present invention;

FIG. 7 is a view showing an example of a preset-information list window;

FIG. 8 is a flowchart explaining a recorded-program list display process performed by the broadcast receiving and recording apparatus according to the first embodiment of the present invention;

FIG. 9 is a view showing an example of a recorded-program list window;

FIG. 10A is a view explaining an example of displaying a pull-down menu in the recorded-program list window of FIG. 9 in response to selection of a folder;

FIG. 10B is a view explaining an example of displaying a pull-down menu in the recorded-program list window of FIG. 9 in response to selection of an audio file;

FIG. 11 is a view showing the recorded-program list window of FIG. 9 in the case where “develop” is selected in the pull-down menu of FIG. 10A after the selection of a folder;

FIG. 12 is a flowchart explaining the former part of a modify process performed by the broadcast receiving and recording apparatus according to the first embodiment of the present invention;

FIG. 13 is a flowchart explaining the latter part of the modify process of FIG. 12 performed by the broadcast receiving and recording apparatus according to the first embodiment of the present invention;

FIG. 14 is a view showing an example of a modify window;

FIG. 15 is a view explaining a preset-information database after the modify process of FIGS. 12 and 13 is performed;

FIG. 16 is a block diagram schematically showing the configuration of a broadcast receiving and recording apparatus according to a second embodiment of the present invention;

FIG. 17 is a view showing the structure of an audio-file database employed in the second embodiment of the present invention;

FIG. 18 is a flowchart explaining a recording start process performed by the broadcast receiving and recording apparatus according to the second embodiment of the present invention;

FIG. 19 is a flowchart explaining a recorded-program list display process performed by the broadcast receiving and recording apparatus according to the second embodiment of the present invention; and

FIG. 20 is a flowchart explaining a modify process performed by the broadcast receiving and recording apparatus according to the second embodiment of the present invention.

### DETAILED DESCRIPTION OF PREFERRED EMBODIMENTS

Embodiments of a broadcast receiving and recording apparatus, a broadcast receiving and recording method, and a broadcast receiving and recording program according the present invention will be explained with reference to the attached drawings.

### Embodiment 1

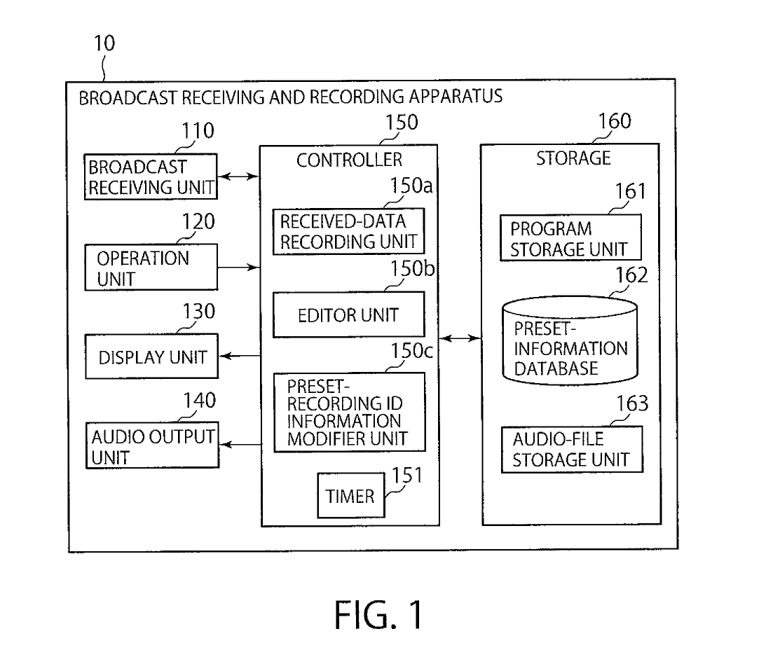

FIG. 1 is a block diagram schematically showing the configuration of a broadcast receiving and recording apparatus 10 according to a first embodiment of the present invention.

The broadcast receiving and recording apparatus 10 shown in FIG. 1 is an apparatus for receiving and recording a radio broadcast, a TV broadcast, etc. The first embodiment will be described with the broadcast receiving and recording apparatus 10 for receiving and recording a radio broadcast.

The broadcast receiving and recording apparatus 10 shown in FIG. 1 is provided with a broadcast receiving unit 110, an operation unit 120, a display unit 130, an audio output unit 140, a controller 150, and a storage 160.

The broadcast receiving unit 110 is constituted by an antenna, a tuner, a decoder, an A/D (analog-to-digital) converter, etc. The tuner extracts a signal of a desired frequency from a broadcast signal received via the antenna and outputs the extracted signal to the decoder. The decoder demodulates the signal and outputs a demodulated analog signal to the A/D converter. The A/D converter converts the analog signal to digital data and outputs the digital data to the controller 150.

The operation unit 120 constituted by a key board, a mouse, etc., outputs a signal to the controller 150 in response to a user operation. The display unit 130 is, for example, a liquid-crystal display device, for displaying several types of information under control by the controller 150. The display unit 130 may be a separate device connected to the broadcast receiving and recording apparatus 10. The audio output unit 140 is constituted by a D/A (digital-to-analog) converter, an amplifier, a speaker, etc. The D/A converter converts the digital data supplied from the controller 150 into an analog signal and outputs the analog signal to the amplifier. The amplifier amplifies the analog signal and outputs an amplified signal to the speaker. The speaker gives off a sound based on the amplified signal.

The controller 150 is provided with a received-data recording unit 150a, an editor unit 150b, a preset-recording ID (identification) information modifier unit 150c, and a timer 151. The controller 150 may be configured with a one-chip processor. In this case, the controller 150 functions as the received-data recording unit 150a, the editor unit 150b, and the preset-recording ID information modifier unit 150c, in accordance with a software program retrieved from a program storage unit 161 of the storage 160, for control of each unit of the broadcast receiving and recording apparatus 10.

The received-data recording unit 150a adds storage ID information to data received by the broadcast receiving unit 110. Then, the received-data recording unit 150a records the received data with the storage ID information in an audio-file storage unit 163 of the storage 160, as corresponding to preset-recording ID information stored in a preset-information database (a first storage unit) 162 of the storage 160. The correspondence between the storage ID information and the preset-recording ID information may be done by including information that identifies the preset-recording ID information in the storage ID information. It is defined that storage ID information is, for example, a file name of a data file of data received by the broadcast receiving unit 110 or a folder name of a folder that stores data files, that identifies recorded contents. It is also defined that preset-recording ID information identifies preset-recording of each broadcast program. The controller 150 works in the same way when it functions as the received-data recording unit 150a in accordance with a software program retrieved from the program storage unit 161.

The editor unit 150b edits storage ID information of data stored in an audio-file storage unit (a second first storage unit) 163 of the storage 160. When storage ID information of data stored in the audio-file storage unit 163 is edited, the preset-recording ID information modifier unit 150c modifies preset-recording ID information stored in the preset-information database 162 based on the edited storage ID information. The controller 150 works in the same way when it functions as the editor unit 150b or the preset-recording ID information modifier unit 150c in accordance with a software program retrieved from the program storage unit 161. In addition to the edition and modification described above, with database management of audio files stored in the audio-file storage unit 163, the controller 150 performs several types of processing to the audio files that belong to a folder structure or a directory structure.

The storage 160 is, for example, a magnetic disk or a semiconductor memory. As described above, the storage 160 is provided with the program storage unit 161, the preset-information database 162, and the audio-file storage unit 163. The program storage unit 161 stores a software program to be executed by the controller 150 when configured with a one-chip processor and other necessary software programs. The audio-file storage unit 163 stores audio files of recorded broadcast programs with storage ID information.

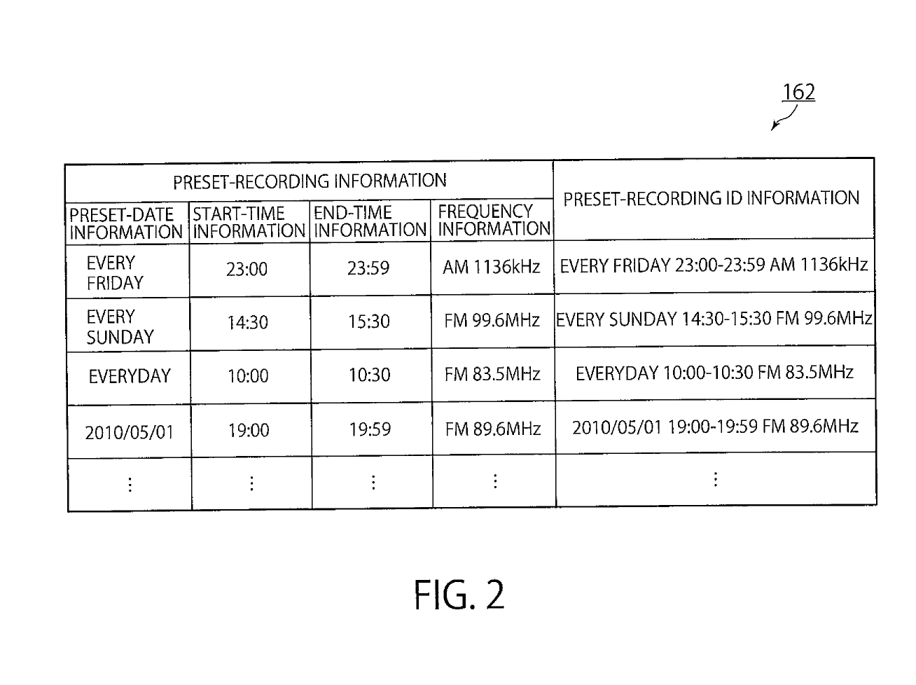

As shown in FIG. 2, the preset-information database 162 stores preset-recording information that indicates information preset for preset-recording and preset-recording ID information that identifies each preset-recording so that there is the correspondence between the preset-recording information and the preset-recording ID information.

The preset-recording information is used in receiving and recording a broadcast program preset by a user for preset-recording. The preset-recording information includes preset-date information that indicates a day to receive a broadcast program, start-time information that indicates the time at which reception and recording of a broadcast program preset for preset-recording start, end-time information that indicates the time at which reception and recording of a broadcast program preset for preset-recording end, and frequency information that indicates a modulation mode for receiving a broadcast program preset for preset-recording and a frequency at which the preset broadcast program is received.

As for a preset date on which preset-recording is performed, a day that comes periodically such as Sunday, a particular one day, and a plurality of particular days can be preset. Examples of types of information that can be preset as the preset date are “every Monday” indicating that recording is performed every Monday, “every Tuesday” indicating that recording is performed every Tuesday, . . . , “everyday” indicating that recording is performed everyday, “15th every month” indicating that recording is performed on 15th every month, etc.

Described next is several operations performed by the broadcast receiving and recording apparatus 10 shown in FIG. 1.

Like an ordinary broadcast receiving and recording apparatus, the broadcast receiving and recording apparatus 10 is capable of preset-recording that is an automatic recording mode that starts and ends in accordance with user preset information. Moreover, the broadcast receiving and recording apparatus 10 is capable of several types of processing to audio files recorded by preset-recording.

In this embodiment, several operations performed by the broadcast receiving and recording apparatus 10 are (1) a recording preset process for presetting information for preset-recording, (2) a recording process for recording a broadcast program preset for preset-recording, (3) a preset-information list display process, (4) a recorded-program list display process, and (5) an operation to a recorded data file or a file folder, for radio broadcast program.

(1) Recording Preset Process

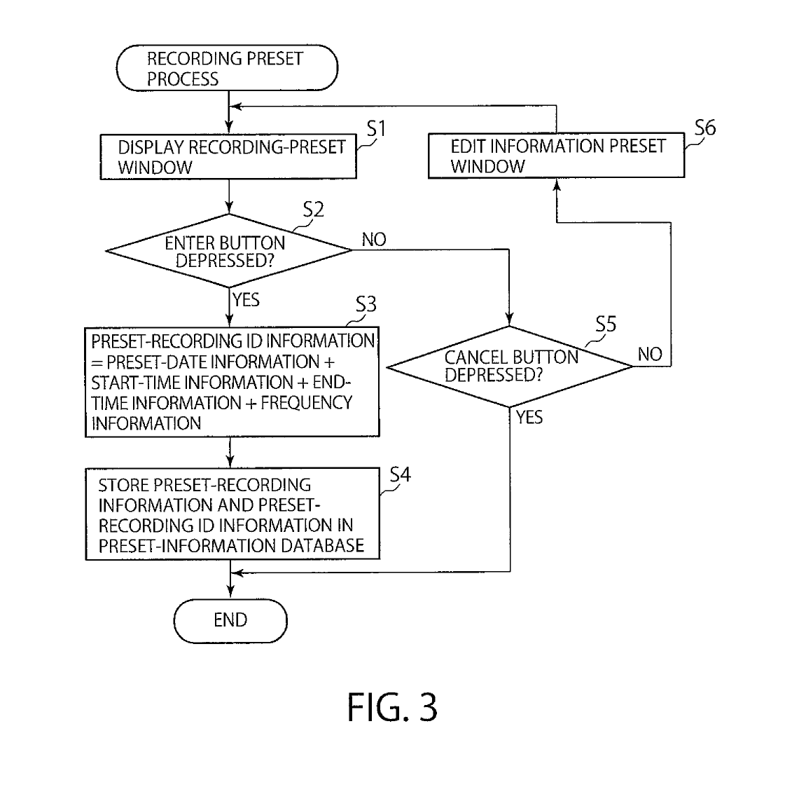

A recording preset process for presetting information for preset-recording of a radio broadcast program will be described with respect to FIG. 3.

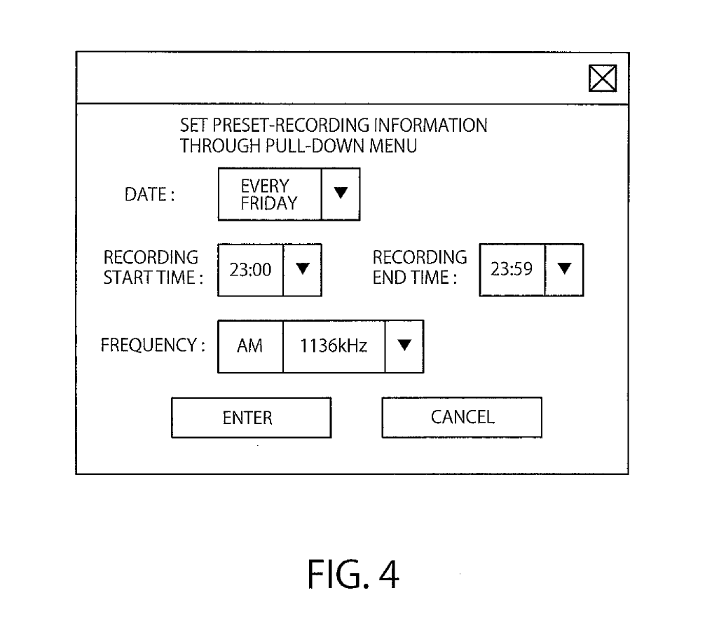

When a user wants to preset a radio broadcast program for preset-recording, the user operates the operation unit 120 for preset-recording instruction. In response to the preset-recording instruction, the operation unit 120 outputs a preset-recording instruction signal to the controller 150. In response to the preset-recording instruction signal, the controller 150 starts the recording preset process shown in FIG. 3 and displays an information preset window such as shown in FIG. 4 on the display unit 130 (step S1).

The user selects a date, a time range (from a recording start time to a recording end time) and a frequency for preset-recording on a pull-down menu in the information preset window through the operation unit 120 and depresses an enter button, thereby instructing preset-recording in accordance with the selected date, time range (recording start time and recording end time) and frequency. The operation unit 120 outputs an operation signal in accordance with the user operation to the controller 150. In response to the operation signal, the controller 150 determines what is operated by the user (step S2, S5 and S6), as follows.

At first, the controller 150 determines whether an enter button in the information preset window is depressed (step S2).

If it is determined that the enter button is depressed (YES in step S2), the controller 150 sets a text that is a combination of information items for preset-recording (a date, a recording start time, a recording end time, and a frequency) as preset-recording ID information (step S3).

Then, the controller 150 records in the preset-information database 162 (step S4) a set of information items for preset-recording (preset-date information that indicates a date on which preset-recording is to be performed, start-time information that indicates a time at which preset-recording is to start, end-time information that indicates a time at which preset-recording is to end, frequency information that indicates a frequency at which a broadcast program subjected to preset-recording is to be received) and preset-recording ID information set in step S3. The set of information items for preset-recording and the preset-recording ID information are recorded in the preset-information database 162 as corresponding to each other as shown in FIG. 2. Several sets of information items and the corresponding preset-recording ID information for preset-recording different broadcast programs can be additionally stored in the preset-information database 162, as shown in FIG. 2.

On the other hand, if it is determined that the enter button is not depressed for a predetermined period set by the timer 152 (NO in step S2), the controller 150 determines whether a cancel button in the information preset window is depressed (step S5). If it is determined that the cancel button is depressed (YES in step S5), the recording preset process ends. On the other hand, if it is determined that the cancel button is not depressed for a predetermined period set by the timer 152 (NO in step S5), the controller 150 edits the information preset window (step S6) in accordance with a user operation (for example, correction of the set date, time range or frequency). The process returns to step S1 to display the information preset window edited in step S6.

The user checks the edited information preset window to see if the selected date, time range and frequency are correct and, if it is correct, depresses the enter button in the information preset window. Then, the controller 150 determines that the enter button is depressed (YES in step S2). Thereafter, the controller 150 sets a text that is a combination of edited information items for preset-recording as preset-recording ID information (step S3) and records in the preset-information database 162 (step S4) a set of information items for preset-recording and the corresponding preset-recording ID information, then the recording preset process ends.

(2) Recording Process

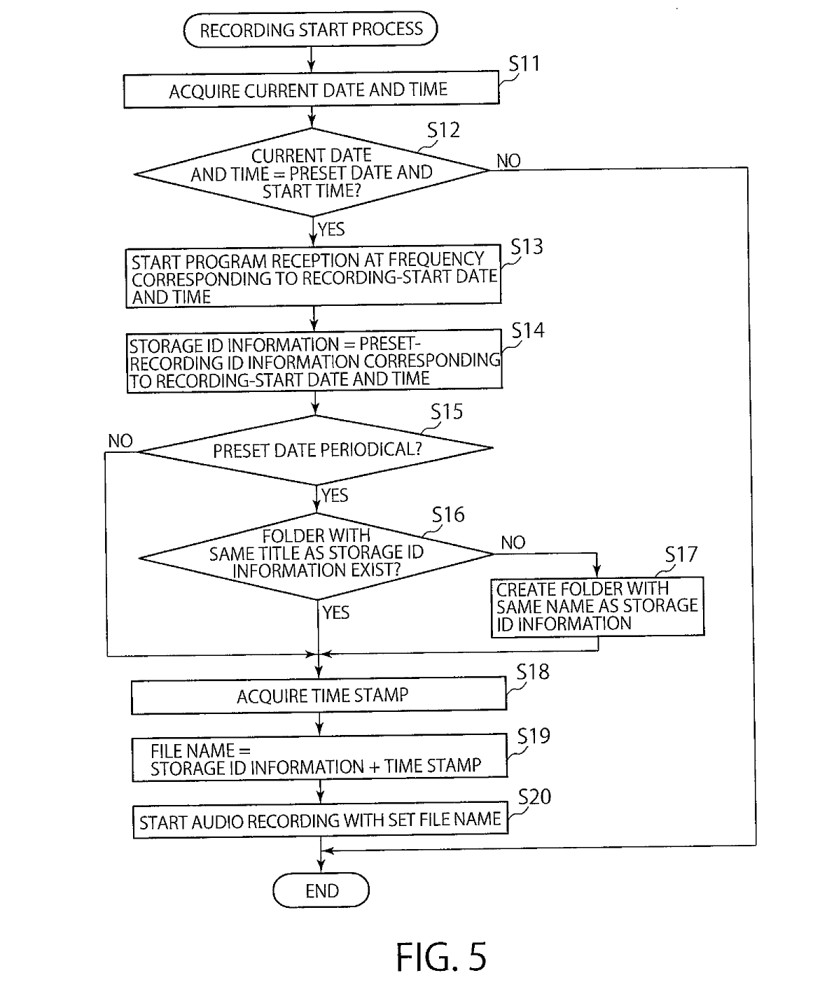

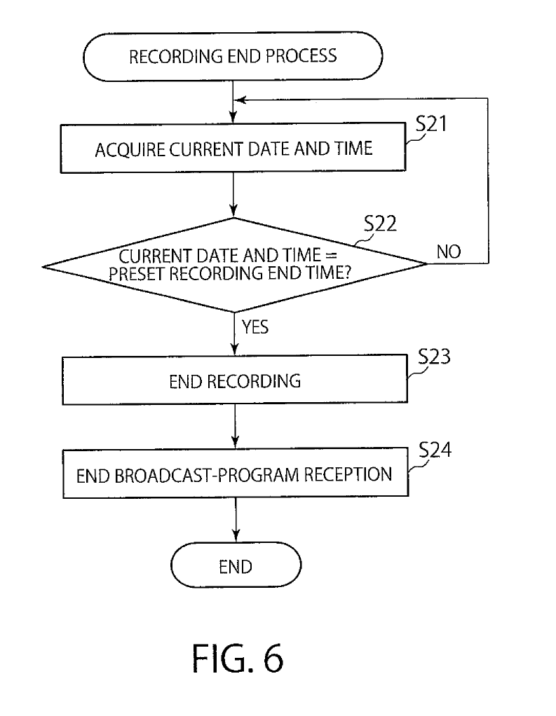

Described next is a process for recording a broadcast program preset for preset-recording. The recording process is constituted by a recording start process and a recording end process shown in FIGS. 5 and 6, respectively.

(2-1) Recording Start Process

The controller 150 repeats the recording start process shown in FIG. 5 by cyclic timer interruption from the timer 151 even if the broadcast receiving and recording apparatus 10 is in a waiting mode or it is just after turned on.

When the recording start process starts, the controller 150 acquires the current date and time from the timer 151 (step S11). Then, the controller 150 looks up the preset date information and recording start-time information stored in the preset-information database 162 to determine whether the current date and time acquired in step S11 are equal to any preset date and start time (step S12).

If it is determined that the current date and time are not equal to any of the preset dates and start times stored in the preset-information database 162 (NO in step S12), the controller 150 ends the recording start process for the current date and time. On the other hand, if it is determined that the current date and time are equal to any of the preset dates and start times stored in the preset-information database 162 (YES in step S12), the controller 150 looks up the preset-information database 162 to retrieve frequency information that corresponds to the preset date and start time to which the current date and time have been determined as equal. Then, controller 150 controls the broadcast receiving unit 110 to receive a broadcast program that is identified by the retrieved frequency information (step S13).

Next, the controller 150 looks up the preset-information database 162 to set the preset-recording ID information corresponding to the preset date and start time to which the current date and time have been determined as equal, as storage ID information that identifies a recorded audio file and a folder in which the recorded audio file is stored (step S14).

Then, the controller 150 determines whether the preset date is periodical (step S15). For example, the controller 150 determines whether the preset-date information includes a word “every”. If, for example, the preset-date information includes a word “every Monday”, the controller 150 determines that the preset date is periodical. If the controller 150 determines that the preset date is not periodical (NO in S15), the process moves to step S18.

If it is determined that the preset date is periodical (YES in step S15), the controller 150 determines whether a folder having the same name as the storage ID information set in step S14 exists in the audio-file storage unit 163 (step S16). If it is determined that there is no folder having the same name as the set storage ID information in the audio-file storage unit 163 (NO in step S16), the controller 150 creates a folder having the same name as the set storage ID information in the audio-file storage unit 163 (step S17).

Then, the controller 150 acquires a time stamp (a year, a month and a date) from the timer 151 (step S18) in any of the following three cases: the preset date is not periodical (NO in step S15); a folder having the same name as the set storage ID information exists (YES in step S16); and a folder having the same name as the set storage ID information is created (step S17).

Next, the controller 150 sets a text that is a combination of the time stamp acquired in step S18 and the storage ID information set in step S14 as an audio file name (step S19). Then, the controller 150 starts a recording process (another routine) for recording audio data supplied from the broadcast receiving unit 110 to receive and record a broadcast program preset for preset-recording (step S20) and then the current recording start process ends.

In FIG. 5, it is determined in step S12 whether the current date and time acquired in step S11 are equal to any preset date and start time stored in the preset-information database 162. However, it is also preferable to: determine in step S12 whether the current time acquired in step S11 is a specific time before any preset start time stored in the preset-information database 162, followed by determination, before the acquisition of a time stamp in step S18, of whether the current date and time are equal to any preset date and start time stored in the preset-information database 162; and to acquire a time stamp in step S18, in the case of positive determination on the date and time. The optional steps put the recording process (step S20) in a waiting mode before the preset time so that recording can start with no time rag.

(2-2) Recording End Process

The recording end process shown in FIG. 6 is called when the recording start process shown in FIG. 5 starts.

When the recording end process starts, the controller 150 acquires the current date and time from the timer 151 (step S21). Then, the controller 150 looks up the preset end-time information stored in the preset-information database 162 to determine whether the current time acquired in step S21 is equal to the preset end time (step S22).

If it is determined that the current time acquired in step S21 is not equal to the preset end time (NO in step S22), the process returns to step S21. On the other hand, if it is determined that the current time is equal to the preset end time (YES in step S22), the controller 150 finishes recording (step S23) and stops a reception operation of the broadcast receiving unit 110 (step S24), thereby finishing the current recording end process.

With the recording start and end processes for preset-recording described above, an audio file of a broadcast program recorded by preset-recording is created in the audio audio-file storage unit 163. If the recording start and end processes described above are performed for a plurality of broadcast programs, a plurality of audio files are created in the audio audio-file storage unit 163 one after another.

(3) Preset-Information List Display Process

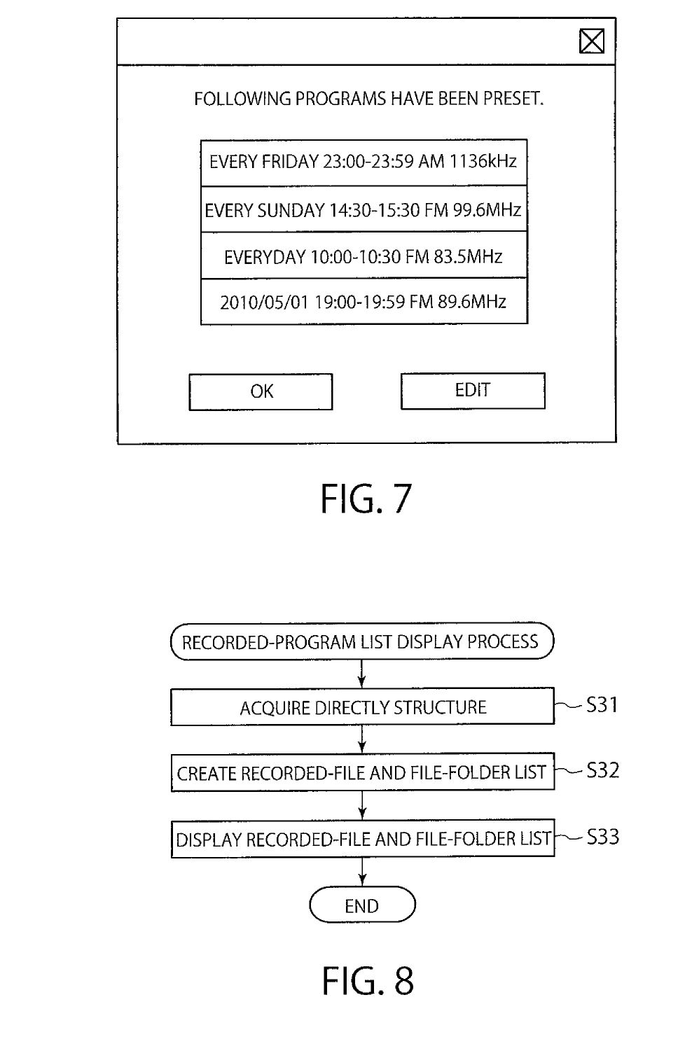

When a user wants to know what broadcast programs have been preset for preset-recording, the user operates the operation unit 120 to instruct displaying of a preset-information list. When the user operates the operation unit 120, an operation signal in accordance with the user operation is output from the operation unit 120 to the controller 150. In response to the operation signal, the controller 150 retrieves preset-recording ID information from the preset-information database 162 and displays the preset-recording ID information on the display unit 130 as a preset-information list. If a plurality of pieces of preset-recording ID information have been recorded in the preset-information database 162 as shown in FIG. 2, the controller 150 creates a preset-information list and displays a preset-information list window on the display unit 130, as shown in FIG. 7. The user can know what information has been preset for preset-recording by referring to the preset-information list. The preset-information list can be edited by depressing an edit button in FIG. 7.

(4) Recorded-Program List Display Process

Described next with reference to FIG. 8 is a recorded-program list display process for displaying recorded broadcast programs that allows a user to process audio files recorded by the recording process described above.

When a user wants to process (reproduce, delete, edit, etc.) an audio file stored in the audio-file storage unit 163, the user operates the operation unit 120 to instruct displaying of a list of folders and audio files stored in the audio-file storage unit 163. In response to the user operation, the operation unit 120 outputs a list window display signal to the controller 150. In response to the list window display signal, the controller 150 starts a recorded-program list display process in accordance with a flowchart shown in FIG. 8.

In FIG. 8, firstly, the controller 150 acquires a directly structure including file names of audio files and folder names of folders for storing the audio files, the audio files and folders being stored in the audio-file storage unit 163 (step S31).

Based on the acquired directly structure, the controller 150 creates a list of folders and audio files located just under a root directly (step S32) and displays the list on the display unit 130 (step S33), with time stamps being displayed for the audio files.

Suppose that preset-recording information stored in the preset-information database 162 is as shown in FIG. 2 and all of the broadcast programs corresponding to the preset-recording information have been recorded by preset-recording. In this case, folders created just under a root directly are: a folder that has stored an audio file of a broadcast program recorded in accordance with preset-recording information “every Friday 23:00-23:59 AM 1136 KHz”; a folder that has stored an audio file of a broadcast program recorded in accordance with preset-recording information “every Sunday 14:30-15:30 FM 99.6 MHz”; a folder that has stored an audio file of a broadcast program recorded in accordance with preset-recording information “everyday 10:00-10:30 FM 83.5 MHz”; a folder that has stored an audio file of a broadcast program recorded in accordance with preset-recording information “2010/05/01 19:00-19:59 FM 89.6 MHz”, and so on.

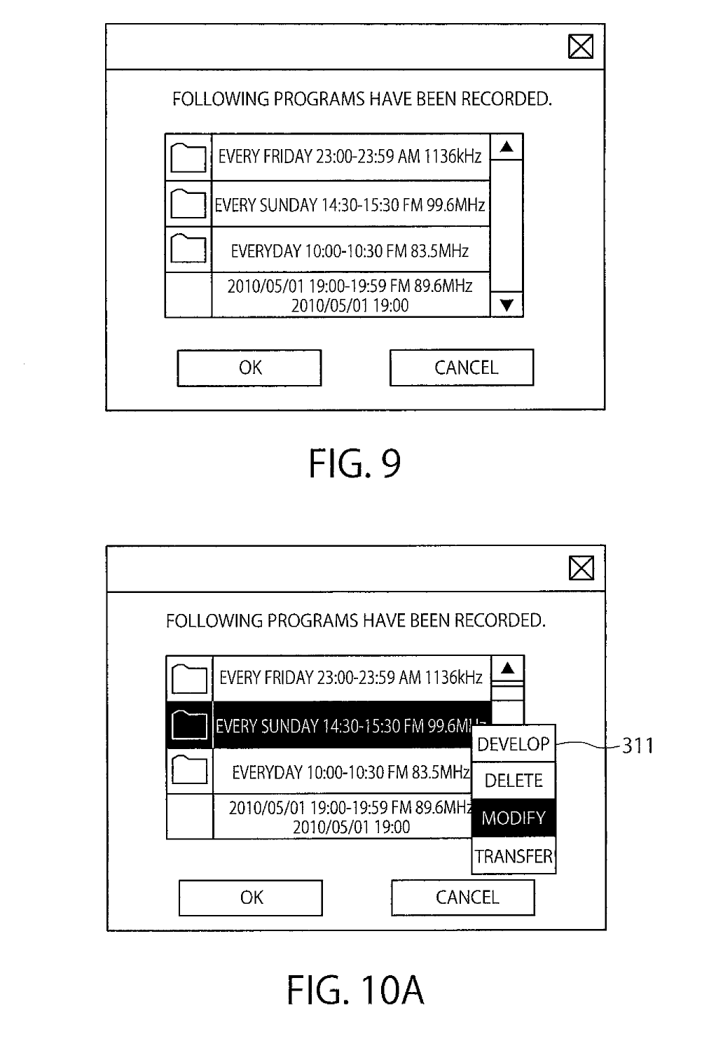

When the folders listed above are created, in step S32, the controller 150 creates a recorded-program list window such as shown in FIG. 9 and, in step S33, displays the list window on the display unit 130.

(5) Operation to Recorded File or File Folder

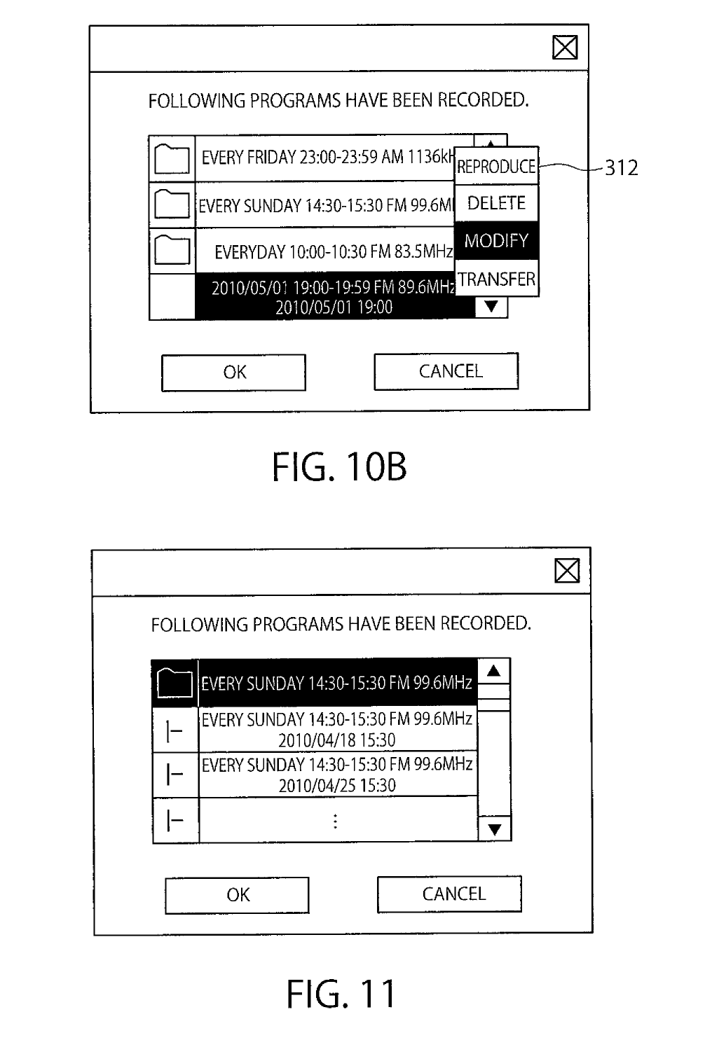

A user is allowed to operate a list window such as shown in FIG. 9 and process recorded data files or folders that have stored the recorded files. When the user selects a folder and clicks the right button of a mouse or pad, the controller 150 displays a pull-down menu 311 on the display unit 130 for operations such as “develop”, “delete”, “modify”, “transfer”, etc., as shown in FIG. 10A. Likewise, when the user selects an audio file and clicks the right button of the mouse or pad, the controller 150 displays a pull-down menu 312 on the display unit 130 for operations such as “reproduce”, “delete”, “modify”, “transfer”, etc., as shown in FIG. 10B.

When the item “develop” is selected in FIG. 10A, the controller 150 creates a list of recorded audio files included in a selected folder on the display unit 130 as shown in FIG. 11, for example. When the item “delete” is selected in FIG. 10A or 10B, the controller 150 deletes a selected folder or audio file. When the item “reproduce” is selected in FIG. 10B, the controller 150 reproduces a selected audio file. When the item “modify” is selected in FIG. 10A or 10B, the controller 150 modifies the name of a selected folder or audio file, which will be described later in detail. Moreover, when the item “transfer” is selected in FIG. 10A or 10B, the controller 150 transfers a selected folder or audio file.

The modify process in this embodiment that is the process of modifying the name of a folder or an audio file has a feature in that when a folder name or a file name is modified, any folder names or file names and preset-recording ID information related to the modified folder or file name are all modified automatically, which will be described below in detail.

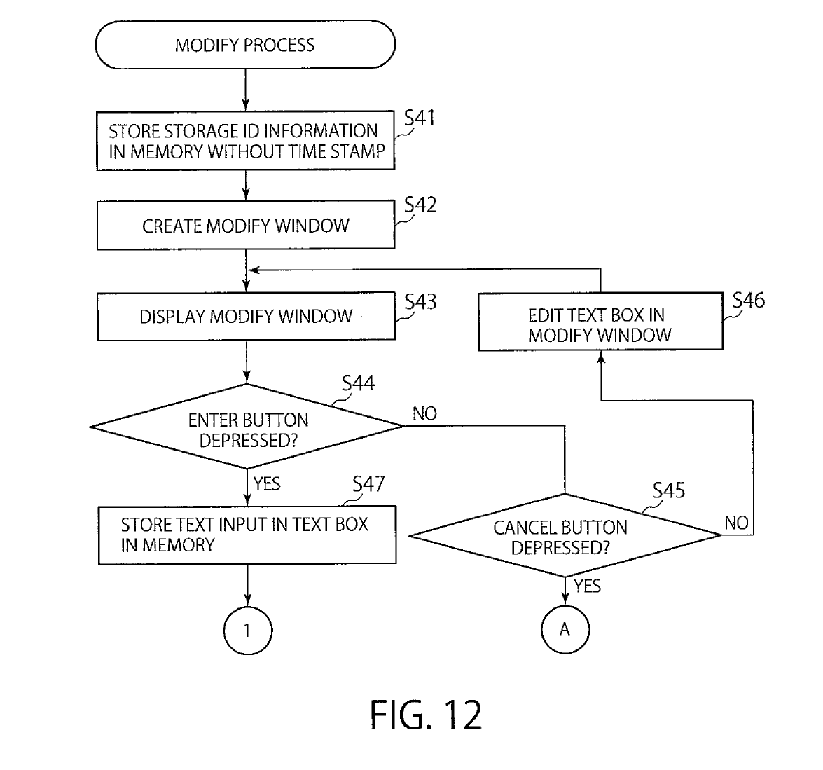

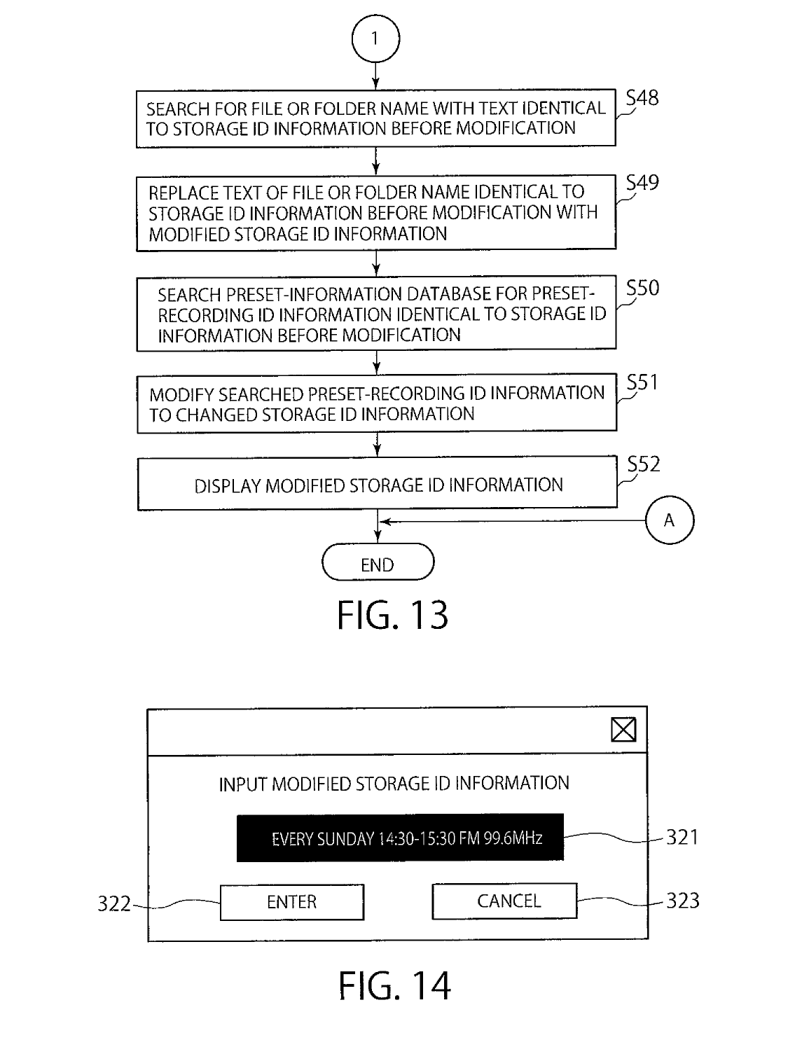

When the item “modify” is selected in FIG. 10A or 10B, the controller 150 starts a modify process for modifying a folder name or an audio file name, as shown in FIGS. 12 and 13.

Firstly, the controller 150 extracts storage ID information from a folder name (=storage ID information) of a selected folder or a file name (=storage ID information+time stamp) of a selected audio file and stores the extracted storage ID information in its internal memory (step S41).

Next, the controller 150 creates a modify window such as shown in FIG. 14 for modifying the name of a selected folder or audio file (step S42) and displays the modify window on the display unit 130 (step S43). In FIG. 14, the modify window is provided with a text box 321 for inputting a new folder or file name. In this embodiment, the storage ID information extracted in step S41 is input in the text box 321.

Suppose that, as shown in FIG. 10A, a user selects a folder “every Sunday 14:30-15:30 FM 99.6 MHz” and then selects the item “modify” in the pull-down menu 311. In this case, the control unit 150 inputs storage ID information “every Sunday 14:30-15:30 FM 99.6 MHz” in the text box 321 to create a modify window.

Likewise, suppose that, as shown in FIG. 10B, a user selects an audio file “2010/05/01 19:00-19:59 FM 89.6 MHz 2010/05/01 19:00” and then selects the item “modify” in the pull-down menu 312. In this case, the controller 150 removes a time stamp “2010/05/01 19:00” from a file name “2010/05/01 19:00-19:59 FM 89.6 MHz 2010/05/01 19:00” and inputs storage ID information “2010/05/01 19:00-19:59 FM 89.6 MHz” in the text box 321 to create a modify window.

The user operates the operation unit 120 to input, for example, “best hit xxx” as storage ID information in the text box 321 and depresses an enter button 322, to instruct the modification of storage ID information.

Returning to the flowchart of FIG. 12, the controller 150 determines whether the enter button 322 in the modify window is depressed (step S44).

If it is determined that the enter button 322 in the modify window is not depressed for a predetermined period set by the timer 152 (NO in step S44), the controller 150 determines whether a cancel button 323 in the modify window is depressed (step S45). If it is determined that the cancel button 323 is not depressed for a predetermined period set by the timer 152 (NO in step S45), the controller 150 edits the information in the text box 321 in accordance with a user operation (step S46). Then, the process returns to step S43 in which the controller 150 displays a modify window with the edited text box 321 on the display unit 130. On the other hand, if it is determined that the cancel button 323 is depressed (YES in step S45), the modify process ends (FIG. 13).

If it is determined that the enter button 322 in the modify window is depressed (YES in step S44), the controller 150 stores the text input in the text box 321 in the modify window, for example, a text “best hit xxx” in its internal memory (step S47).

Then, the process moves to step S48 (FIG. 13) in which the controller 150 searches the audio-file storage unit 163 for an audio file name or a folder name including the text string identical to the storage ID information before modification that has been stored in its internal memory (step S48). Then, the controller 150 replaces the text string of the audio file name or folder name identical to the storage ID information before modification with the modified storage ID information, thereby modifying the file name or folder name (step S49). Accordingly, the controller 150 (preset-recording ID information modifier unit 150c) functions as a file- or folder-name modifier.

In the example above, the controller 150 changes a folder name “every Sunday 14:30-15:30 FM 99.6 MHz” of a folder among the audio files and folders stored in the audio-file storage unit 163 to “best hit xxx”. Moreover, the controller 150 changes storage ID information before modification “every Sunday 14:30-15:30 FM 99.6 MHz” of an audio file name, for example, “every Sunday 14:30-15:30 FM 99.6 MHz 2010/05/02 15:30.mps” to the storage ID information after modification “best hit xxx”. In this way, the audio file name is modified to “best hit xxx 2010/05/02 15:30.mps”. In a similar manner, when a file name of an audio file is modified, a folder name of a folder that stores the audio file is also modified based on the modified file name.

Next, the controller 150 searches the preset-information database 162 for preset-recording ID information identical to the storage ID information before modification that has been stored in its internal memory (step S50). Then, the controller 150 modifies the searched preset-recording ID information to the changed storage ID information (step S51). Accordingly, a file name of an audio file or a folder name of a folder that stores the audio file stored in the audio-file storage unit 163 and preset-recording ID information stored in the preset-information database 162 are modified so that the file name or folder name and the preset-recording ID information include the same text string.

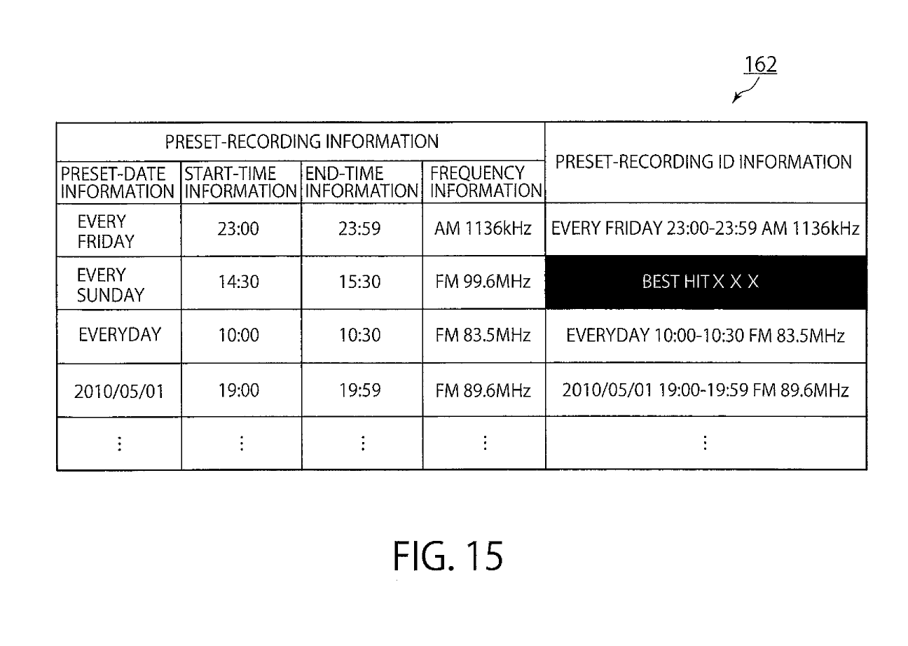

For example, in the example above, the storage ID information “every Sunday 14:30-15:30 FM 99.6 MHz” is changed to “best hit xxx” and the preset-recording ID information “every Sunday 14:30-15:30 FM 99.6 MHz” identical to the storage ID information before modification is searched and changed to “best hit xxx”. This can be achieved because the storage ID information includes information that identifies the preset-recording ID information. Through these steps, the preset-information database 162 is modified from the state shown in FIG. 2 to that shown in FIG. 15.

Then, the controller 150 displays the modified storage ID information on the display unit 130 (step S52) and ends the modify process.

As described above, in the broadcast receiving and recording apparatus 10, when a file name of an audio file or a folder name of a folder that stores the audio file stored in the audio-file storage unit 163 is modified, the corresponding preset-recording ID information stored in the preset-information database 162 is also modified. With this modification function, when a user modifies a file name of an audio file of a broadcast program or a folder name of a folder that stores the audio file to a plain name as storage ID information, preset-recording ID information that indicates preset information for preset-recording the broadcast program is also automatically modified to a plain name. Therefore, the user can easily recognize the preset information for preset-recording and the contents of an audio file of a broadcast program recorded by preset-recording.

Moreover, with the modification function described above, when a user modifies a file name of an audio file or a folder name of a folder that stores the audio file stored in the audio-file storage unit 163 as storage ID information, it is not required for the user to modify the corresponding preset-recording ID information stored in the preset-information database 162 (which is modified automatically as described above). Therefore, the burden of modification on a user can be lightened. Moreover, since when storage ID information is modified, the corresponding preset-recording ID information is also modified, high consistency is achieved between the information stored in the audio-file storage unit 163 and in the preset-information database 162 after modification.

### Embodiment 2

In the first embodiment, storage ID information that identifies recorded contents stored in the audio-file storage unit 163, identical to preset-recording ID information that identifies each preset-recording stored in the preset-information database 162, is included in an audio file name or a folder name so that the preset-recording ID information is associated with an audio file or a folder that stores the audio file. The association (or correspondence) between preset-recording ID information and an audio file or a folder that stores the audio file achieves a modify function in which when an audio file name or a folder name is modified, the corresponding preset-recording ID information is automatically modified.

One feature of the present invention lies in the association (correspondence) between preset-recording ID information that identifies each preset-recording and, an audio file and a folder that stores the audio file. How to identify information preset for preset-recording, the structure of an audio file, how to store information in the preset-information database 162 and the audio-file storage unit 163, etc. can be arbitrarily changed.

A second embodiment which will be described below uses a table of correspondence in an audio file database for the correspondence between an audio file and a folder that stores the audio file, and storage ID information that identifies recorded contents using preset-recording ID information that identifies each preset-recording.

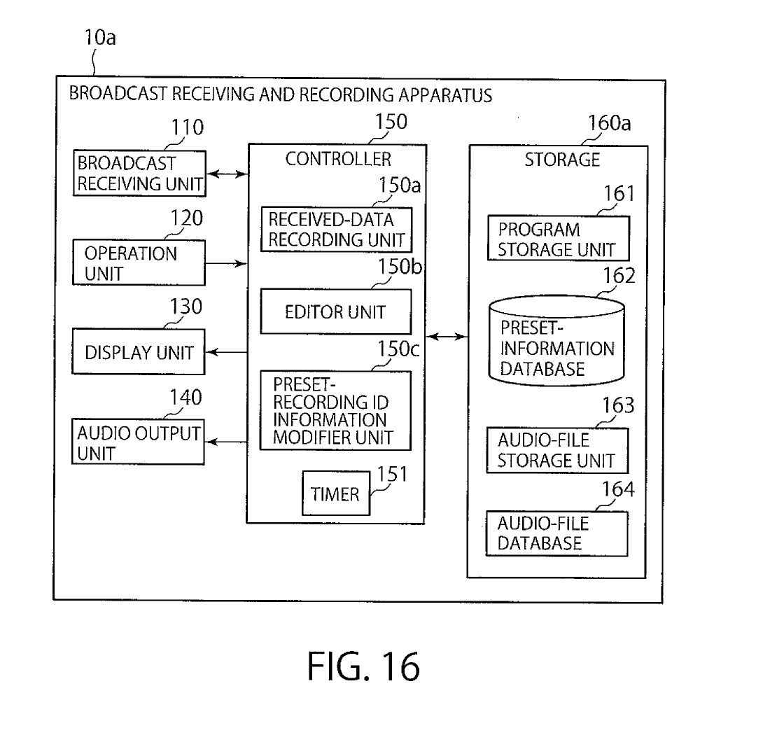

A broadcast receiving and recording apparatus 10a shown in FIG. 16 is an apparatus for receiving and recording a radio broadcast, a TV broadcast, etc. The second embodiment will also be described with the broadcast receiving and recording apparatus 10a for receiving and recording a radio broadcast.

The broadcast receiving and recording apparatus 10a shown in FIG. 16 is provided with a storage 160a in place of the storage 160, in addition to the broadcast receiving unit 110, the operation unit 120, the display unit 130, the audio output unit 140, and the controller 150, the same as the broadcast receiving and recording apparatus 10 shown in FIG. 1.

The storage 160a that is, for example, a magnetic disk or a semiconductor memory, is provided with an audio-file database (a third storage unit) 164 in addition to the program storage unit 161, the preset-information database 162, and the audio-file storage unit 163, the same as the broadcast receiving and recording apparatus 10 shown in FIG. 1.

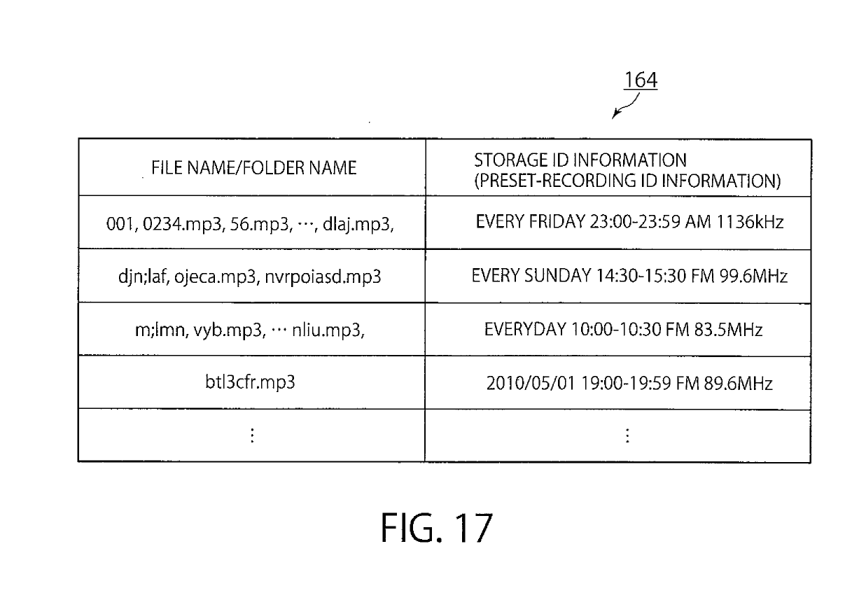

As shown in FIG. 17, the audio-file database 164 is equipped with a table for the correspondence between audio file names and folder names, and storage ID information (preset-recording ID information). The preset-recording ID information is used as the storage ID information in the embodiment.

In the same manner as the first embodiment, the broadcast receiving and recording apparatus 10a is capable of preset-recording of a broadcast program to be received in accordance with a user operation. Also, in the same manner as the first embodiment, a user can check a preset-information list window (FIG. 7) to know what information has been preset for preset-recording.

Then, the broadcast receiving and recording apparatus 10a records a broadcast program in accordance with the preset-recording information that has been preset for preset-recording of the broadcast program. When the broadcast program is recorded, the broadcast receiving and recording apparatus 10a stores a file name of a recorded audio file and the preset-recording ID information that identifies the preset-recording that has been set for recording the broadcast program, as storage ID information, in the audio-file database 164 so that the audio file name (and a folder name for the audio file) and the storage ID information (preset-recording ID information) correspond to each other.

A recorded broadcast program can be identified by referring to a recorded-program list window (not shown) displayed on the display unit 130. Different from the recorded-program list window shown in FIG. 9, displayed in the recorded-program list window, in the second embodiment, is preset-recording ID information stored in the audio-file database 164, as storage ID information. Storage ID information (preset-recording ID information) corresponding to an audio file name can be modified in the recorded-program list window in accordance with a user operation.

In this embodiment, operations performed by the broadcast receiving and recording apparatus 10a, different from the first embodiment, are (6) a recording start process for recording a broadcast program preset for preset-recording, (7) a recorded-program list display process, and (8) a modify process to storage ID information. In this embodiment, (1) a recording preset process for presetting information for preset-recording and (2-2) a recording end process for ending the recording of a broadcast program preset for preset-recording are the same as those in the first embodiment.

(6) Recording Start Process

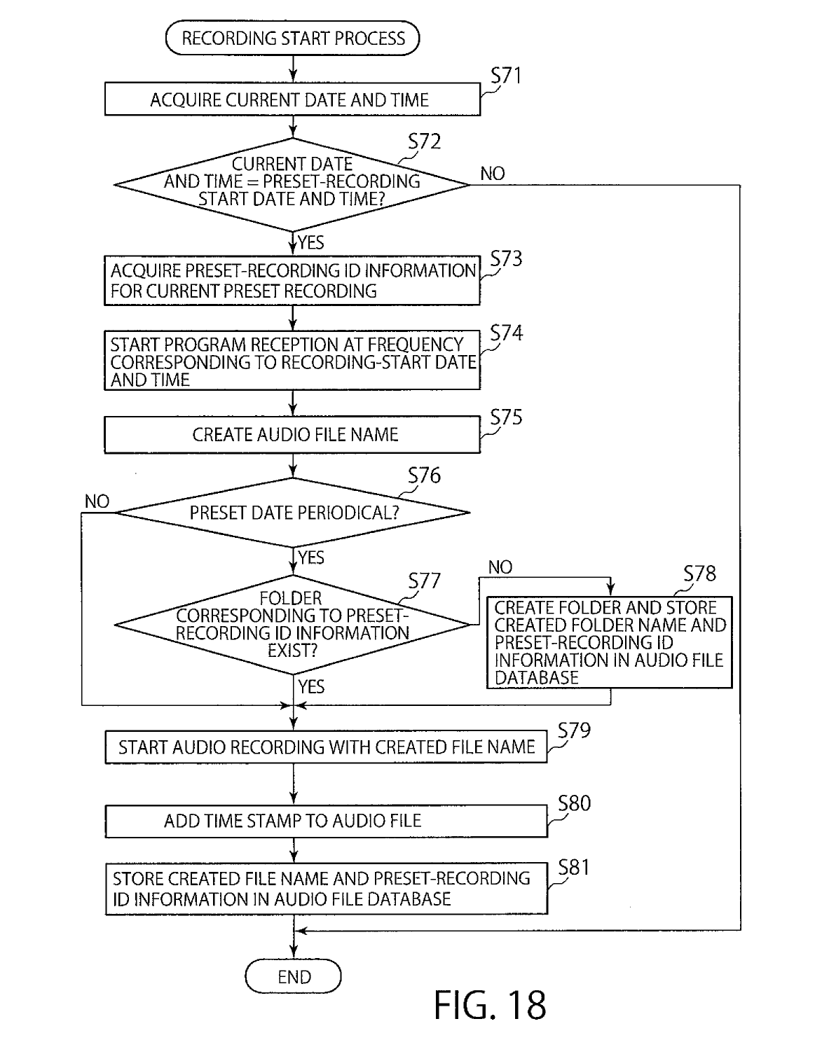

A recording start process will be described with reference to FIG. 18. The controller 150 repeats the recording start process by cyclic timer interruption from the timer 151 even if the broadcast receiving and recording apparatus 10a is in a waiting mode or it is just after turned on.

When the recording start process starts, the controller 150 acquires the current date and time from the timer 151 (step S71). Then, the controller 150 looks up the preset date information and recording start-time information stored in the preset-information database 162 to determine whether the current date and time acquired in step S71 are equal to any preset date and start time (step S72).

If it is determined that the current date and time are not equal to any of the preset dates and start times stored in the preset-information database 162 (NO in step S72), the controller 150 ends the recording start process for the current date and time. On the other hand, if it is determined that the current date and time are equal to any of the preset dates and start times stored in the preset-information database 162 (YES in step S72), the controller 150 looks up the preset-information database 162 to acquire preset-recording ID information for the current preset-recording (step S73).

Subsequently, the controller 150 looks up the preset-information database 162 to retrieve frequency information that corresponds to the preset date and start time to which the current date and time have been determined as equal. Then, the controller 150 controls the broadcast receiving unit 110 to receive a broadcast program that is identified by the retrieved frequency information (step S74).

Subsequently, the controller 150 creates a file name of an audio file of the received broadcast program (step S75). Any method can be employed for creating a file name.

Then, the controller 150 determines whether the preset date is periodical (step S76). For example, the controller 150 determines whether the preset-date information includes a word “every”. If, for example, the preset-date information includes a word “every Monday”, the controller 150 determines that the preset date is periodical. If the controller 150 determines that the preset date is not periodical (NO in S76), the process moves to step S79.

If it is determined that the preset date is periodical (YES in step S76), the controller 150 determines whether a folder that corresponds to the preset-recording ID information acquired in step S73 exists in the audio-file storage unit 163 (step S77).

If it is determined that there is no folder in the audio-file storage unit 163, that corresponds to the preset-recording ID information (NO in step S77), the controller 150 creates a folder with an arbitrary name in the audio-file storage unit 163 and stores the created folder name and preset-recording ID information (preset-recording ID information for the current preset-recording) in the audio file database 164 so that the folder name and the preset-recording ID information correspond to each other (step S78).

Then, the controller 150 creates an audio file with the file name created in step S75 and starts recording of audio data supplied from the broadcast receiving unit 110 (step S79) in any of the following three cases: the preset date is not periodical (NO in step S76); there is a folder in the audio-file storage unit 163, that corresponds to the preset-recording ID information (YES in step S77); and a folder is created (step S78).

Subsequently, the controller 150 adds a time stamp acquired from the timer 151 to the audio file created in step S79 (step S80). Then, the controller 150 stores the preset-recording ID information acquired in step S73 and the file name created in step S75 in the audio-file database 164 so that the preset-recording ID information and the file name correspond to each other (step S81), and ends the recording start process for the current preset-recording.

(7) Recorded-Program List Display Process

Described next is a recorded-program list display process in which the broadcast receiving and recording apparatus 10a displays a list of recorded broadcast programs in the case where recorded broadcast programs have been recorded by preset-recording in accordance with the preset-recording information stored in the preset-information database 162, as shown in FIG. 2 for example.

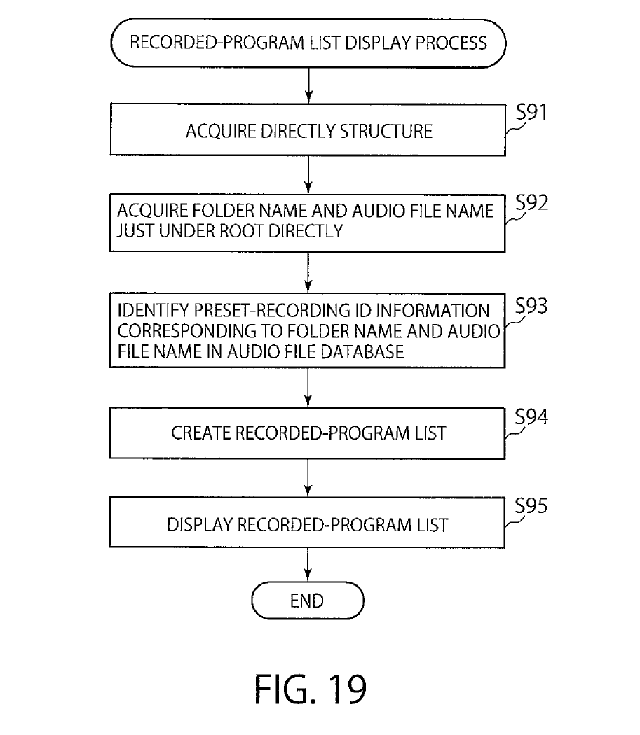

When a user operates the operation unit 120 to instruct displaying of a list of recorded broadcast programs, the operation unit 120 outputs a list window display signal to the controller 150. In response to the list window display signal, the controller 150 starts a recorded-program list display process in accordance with a flowchart shown in FIG. 19.

In FIG. 19, firstly, the controller 150 acquires a directly structure including file names of audio files and folder names of folders for storing the audio files, the audio files and folders being stored in the audio-file storage unit 163 (step S91).

Based on the acquired directly structure, the controller 150 acquires folder names and audio file names located just under a root directly (step S92). Then, the controller 150 looks up the audio-file database 164 to identify preset-recording ID information, as storage ID information, that corresponds to each folder name and each audio file name (step S93).

Based on the identified preset-recording ID information as the storage ID information, the controller 150 creates a recorded-program list window such as shown in FIG. 9, with time stamps for audio files (step S94) and displays the list window on the display unit 130 (step S95).

A user is allowed to operate a list window such as shown in FIG. 9 and operate recorded files or folders that have stored the recorded files. When the user selects a folder and clicks the right button of a mouse or pad, the controller 150 displays a pull-down menu 311 on the display unit 130 for operations such as “develop”, “delete”, “modify”, “transfer”, etc., as shown in FIG. 10A. Likewise, when the user selects an audio file and clicks the right button of the mouse or pad, the controller 150 displays a pull-down menu 312 on the display unit 130 for operations such as “reproduce”, “delete”, “modify”, “transfer”, etc., as shown in FIG. 10B.

In response to these user operations, when displaying a folder name or an audio file name, the controller 150 looks up the audio-file database 164 to identify preset-recording ID information, as storage ID information, that corresponds to each folder name and each audio file name, in the same manner as step S93 in FIG. 19. Then, the controller 150 converts a folder name into the identified preset-recording ID information as the storage ID information and also converts a file name into the identified preset-recording ID information as the storage ID information and a time stamp, and displays the converted preset-recording ID information on the display unit 130.

(8) Modify Process to Storage ID Information.

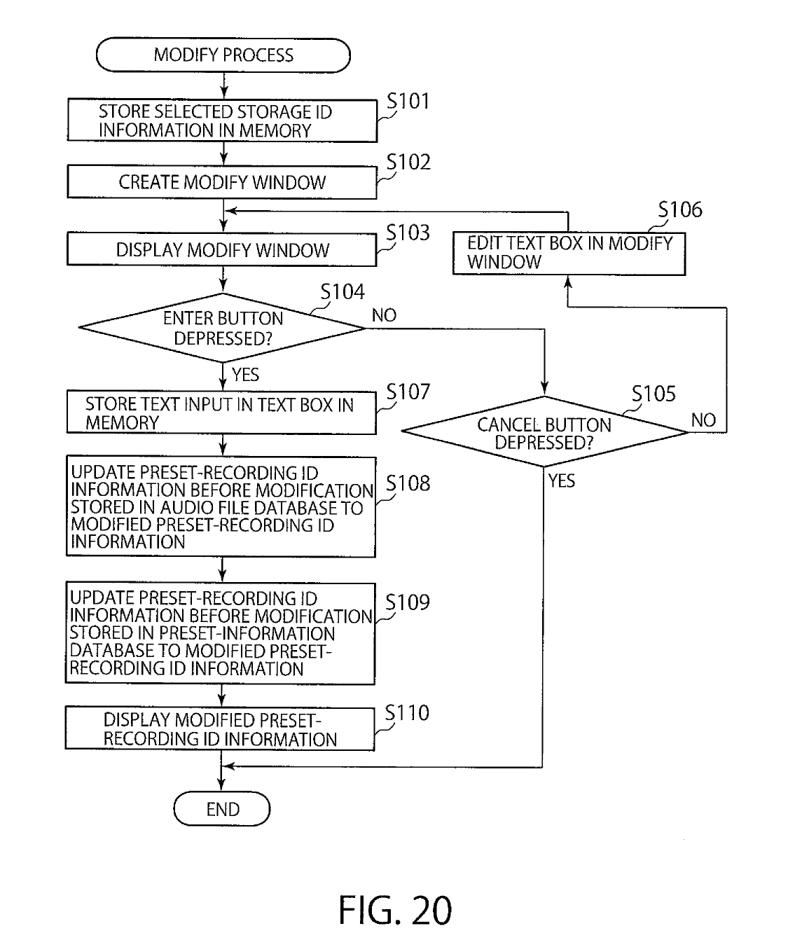

Described next is a modify process in which the broadcast receiving and recording apparatus 10a modifies a folder name or an audio file name, with respect to FIG. 20.

When modification is instructed by a user operation, the controller 150 starts a modify process shown in FIG. 20 to store a folder name or an audio file name (storage ID information) selected by a user in its internal memory (step S101).

Next, the controller 150 creates a modify window such as shown in FIG. 14 for modifying the name of a selected folder or audio file (step S102) and displays the modify window on the display unit 130 (step S103).

Through steps S104 to S106 (in the same manner as steps S44 to S46 in FIG. 12, respectively), the controller 150 decides a folder name or an audio file name (a text input in the text box 321 in the modify window) after modification and stores the decided name in its internal memory (step S107).

Subsequently, the controller 150 searches the audio-file database 164 for preset-recording ID information, as storage ID information, that is identical to the folder name or the audio file name before modification stored in its internal memory in step S101 and updates the preset-recording ID information to the modified preset-recording ID information (the folder name or the audio file name after modification) also stored in its internal memory in step S107 (step S108).

Moreover, the controller 150 searches the preset-information database 162 for preset-recording ID information that is identical to the folder name or the audio file name before modification stored in its internal memory in step S101 and updates the preset-recording ID information to the modified preset-recording ID information (the folder name or the audio file name after modification) also stored in its internal memory in step S107 (step S109).

Then, the controller 150 displays the modified preset-recording storage ID information as the storage ID information on the display unit 130 (step S110) and ends the modify process.

As described above in detail, in the second embodiment, in the same manner as the first embodiment, when a folder name or an audio file name is modified, the corresponding preset-recording ID information stored in the preset-information database 162 is also modified.

The modification is achievable on a user interface with no proses of a file itself such as an audio file.

As described above, the correspondence is made between folder and file names and preset-recording ID information by including preset-recording ID information in a folder name or a file name in the first embodiment and by employing the audio-file database 164 in the second embodiment. The correspondence can be made by any method as long as preset-recording, because of which a folder or a data file has been created for a particular broadcast program among different broadcast programs each recorded by preset-recording, can be identified when the name of the folder or data file created for the particular broadcast program is modified.

It is further understood by those skilled in the art that the foregoing description is a preferred embodiment of the disclosed device or method and that various changes and modifications may be made in the invention without departing from the sprit and scope thereof.

For example, in the first embodiment, the preset-recording ID information is created with a text that is a combination of factors that are a date, a recording start time, a recording end time and a frequency, all of them being selected on an information preset window for preset-recording. The contents of a text for the preset-recording ID information is, however, not limited to those factors.

In the embodiments described above, when the controller 150 modifies a folder name or an audio file name, it also modifies the corresponding preset-recording ID information. However, it is also preferable for the controller 150 that, when it modifies preset-recording ID information, it identifies a folder name or a file name created because of preset-recording that is identified by the modified preset-recording ID information and modifies the identified folder or file name.

Moreover, in the embodiments described above, a radio broadcast is received through the broadcast receiving unit 110 and recorded to create an audio file, with modification of preset-recording ID information in accordance with modification of a folder name or a file name. However, not only a radio broadcast, the broadcast receiving unit 110 may receive a TV broadcast. Moreover, the broadcast receiving and recording apparatus 10 or 10a may be provided with a communication unit such as NIC (Network Interface Card) to receive Internet radio broadcast.

Moreover, in the embodiments described above, the controller 150 displays folder and audio file names only in the recorded-program list window. However, the number of audio files of recorded broadcast programs may also be displayed as corresponding to storage ID information. In this case, the controller 150 looks up the audio-file database 164 to acquire the number of file names corresponding to storage ID information, namely, the number of audio files of recorded broadcast programs and displays the storage ID information and the number of audio files of recorded broadcast programs as corresponding to each other in the recorded-program list window.

Moreover, in the embodiments described above, when a folder name of a folder is modified, a file name of the audio file stored in this folder is also modified. However, it may be omitted to modify the file name of an audio file stored in a folder for which a folder name has been modified.

Moreover, a program running on a computer to achieve the function of the broadcast receiving and recording apparatus 10 or 10a is embodied in the present invention. Such a program may be retrieved from a non-transitory computer readable storage medium such as a CD-ROM or transferred over a network and installed in a computer to run on the operating system.

As described above in detail, the present invention provides a broadcast receiving and recording apparatus, a broadcast receiving and recording method, and a broadcast receiving and recording program with a specific function by which a user can easily identify the information preset for preset-recording and the contents of recorded broadcast program data with user-friendly modification of information preset for preset-recording, file names, etc.

What is claimed is:

1. A broadcast receiving and recording apparatus comprising:
a first storage unit configured to store preset information that is preset for preset-recording that is an automatic recording mode for recording a broadcast program in accordance with the preset information and store preset-recording identification information that identifies the preset information so that the preset information and the preset-recording identification information correspond to each other;
a broadcast receiving unit configured to receive a broadcast program in accordance preset information that has been preset for preset-recording of the received broadcast program;
a second storage unit configured to store data of the received broadcast program;
a received-data recording unit configured to add storage identification information, that identifies the data of the received broadcast program in accordance with preset information that has been preset and stored in the first storage unit for preset-recording of the received broadcast program, to the data of the received broadcast program and to record the data of the received broadcast program added with the storage identification information in the second storage unit so that the data of the received broadcast program added with the storage identification information corresponds to the preset-recording identification information that identifies the preset information that has been preset for preset-recording of the received broadcast program;
an editor unit configured to edit the storage identification information added to the data of the received broadcast program and stored in the second storage unit; and
a modifier unit configured, when the storage identification information added to the data of the received broadcast program and stored in the second storage unit is edited, to modify the preset-recording identification information stored in the first storage unit and corresponding to the storage identification information added to the data of the received broadcast program and stored in the second storage unit, based on the edited storage identification information.

2. The broadcast receiving and recording apparatus according to claim 1, wherein the storage identification information includes information that identifies the preset-recording identification information, and when the storage identification information added to the data of the received broadcast program stored in the second storage unit is edited, the modifier unit identifies the preset-recording identification information corresponding to the edited storage identification information edited based on data that identifies the preset-recording identification information included in the storage identification information before edition and modifies the identified preset-recording identification information based on the edited storage identification information.

3. The broadcast receiving and recording apparatus according to claim 1 further comprising a third storage unit configured to store a file name of a data file that stores the data stored in the second storage unit and a folder name of a folder that store the data file, and store storage identification information that identifies the data stored in the second storage unit so that the file and folder names, and the storage identification information correspond to each other, the preset-recording identification information being used as the storage identification information,
wherein, when the storage identification information for the data stored in the second storage unit is edited, the modifier unit looks up the third storage unit to identify the preset-recording identification information that corresponds to the edited storage identification information and modify the identified preset-recording identification information based on the edited storage identification information.

4. The broadcast receiving and recording apparatus according to claim 1, the storage identification information is a file name of a data file of the data of the received broadcast program, wherein, when the file name is edited by the editor unit, the modifier unit modifies a folder name of a folder that stores the data file based on the edited file name.

5. The broadcast receiving and recording apparatus according to claim 1, the storage identification information is a folder name of a folder that stores a data file of the data of the received broadcast program, wherein, when the folder name is edited by the editor unit, the modifier unit modifies a file name of a data file stored in the folder based on the edited folder name.

6. The broadcast receiving and recording apparatus according to claim 1, wherein the received-data recording unit adds the storage identification information that corresponds to the preset-recording identification information, to the data of the received broadcast program.

7. A broadcast receiving and recording method comprising the steps of:
storing preset information that is preset for preset-recording that is an automatic recording mode for recording a broadcast program in accordance with the preset information and storing preset-recording identification information that identifies the preset information;
receiving a broadcast program in accordance with preset information that has been preset for preset-recording of the received broadcast program;
adding identification information to data of the received broadcast program and storing the data with the identification information; and
when the identification information added to the stored data of the received broadcast is edited, identifying preset-recording that has been set for the stored data of the received broadcast program and modifying preset-recording identification information that corresponds to the preset-recording based on the edited identification information.

8. A non-transitory computer readable storage medium storing a computer program running on a computer to achieve function of a broadcast receiving and recording apparatus, the program comprising:
a program code of storing preset information that is preset for preset-recording that is an automatic recording mode for recording a broadcast program in accordance with the preset information and storing preset-recording identification information that identifies the preset information so that the preset information and the preset-recording identification information correspond to each other;
a program code of receiving a broadcast program in accordance preset information that has been preset for preset-recording of the broadcast program;
a program code of storing data of a broadcast program received in accordance with the preset information, added with storage identification information that identifies the data of the received broadcast program and includes preset-recording identification information corresponding to the data of the received broadcast program;
a program code of editing the storage identification information added to the stored data; and
a program code of, when the preset-recording identification information included in the storage identification information is edited, modifying the stored preset-recording identification information to the contents of the edited preset-recording identification information.

9. A computer program running on a computer to achieve function of a broadcast receiving and recording apparatus, the program comprising:
a program code of storing preset information that is preset for preset-recording that is an automatic recording mode for recording a broadcast program in accordance with the preset information and storing preset-recording identification information that identifies the preset information so that the preset information and the preset-recording identification information correspond to each other;
a program code of receiving a broadcast program in accordance preset information that has been preset for preset-recording of the broadcast program;
a program code of storing data of a broadcast program received in accordance with the preset information, added with storage identification information that identifies the data of the received broadcast program and includes preset-recording identification information corresponding to the data of the received broadcast program;
a program code of editing the storage identification information added to the stored data; and
a program code of, when the preset-recording identification information included in the storage identification information is edited, modifying the stored preset-recording identification information to the contents of the edited preset-recording identification information.
